(19) United States
(12) Patent Application Publication
(10) Pub. No.: US 2021/0163169 A1
(43) Pub. Date: Jun. 3, 2021

(54) BOTTOM FEED PORTABLE BOTTLE FILLING STATION

(71) Applicant: Gary Bohamed, Valencia, CA (US)

(72) Inventor: Gary Bohamed, Valencia, CA (US)

(73) Assignee: EMBO, LLC, Valencia, CA (US)

(21) Appl. No.: 17/103,512

(22) Filed: Nov. 24, 2020

Related U.S. Application Data
(60) Provisional application No. 62/942,440, filed on Dec. 2, 2019.

(51) Int. Cl. B65D 1/20; A45F 3/18; B65D 51/24

(52) U.S. Cl. CPC B65D 1/20; B65D 51/24; A45F 3/18

(57) ABSTRACT

A bottom feed portable bottle filling station includes a cart having a frame that defines a top surface and an inside space into which a liquid storage tank is positioned. A pump unit is in fluid communication with the tank to supply liquid stored within the tank to a liquid distribution chamber. A plurality of bottom-feed dispensers is in fluid communication with the liquid distribution chamber and each of the dispensers includes a valve and nozzle that are controlled by a switch. The nozzle and switch are positioned along the bottom wall of the dispenser and engage a removable water bottle having a bottom-feed valve along the bottom end.

### CROSS-REFERENCE TO RELATED APPLICATIONS

This application claims the benefit of U.S. Application Ser. No. 62/942,440 Filed on Dec. 2, 2019, the contents of which are incorporated herein by reference.

### TECHNICAL FIELD

The present invention relates generally to portable hydration systems, and more particularly to a bottom feed potable bottle filling station for hygienically filling water bottles.

### BACKGROUND

The statements in this section merely provide background information related to the present disclosure and may not constitute prior art.

It is common for participants of organized sporting events to be provided with water or other beverages for hydration during the contest. Whether the event is at the high school, college, or professional level, each team typically has one or more assistants who are responsible for providing beverages to the athletes.

Owing to the minimal facilities that are often available during outdoor events, the most common means for providing the beverages is through the use of refillable water bottles that are shared by everyone. In this regard, the bottles are typically filled by removing the cap and filling the topless bottle with a hose, igloo cooler/dispenser, or by physically dunking the bottle into a central cooler that contains a beverage. During this process, contaminants such as dirt, grass and other forms of debris located along the outside of the bottles and/or the assistants' hands are transferred into the beverage bottle top, igloo spigot and ultimately consumed by the players. Aside from exposing the players to illness, this cumbersome and slow process typically causes a significant portion of the beverage within the water bottle to become spilled before the assistant can replace the cap. As such, it is not uncommon for athletes to be handed a water bottle that is dirty and empty.

In addition to the above, the COVID-19 pandemic of 2020 has demonstrated the need for additional safety procedures to further prevent the spread of harmful contagions. As a result, many institutions are hesitant to use heretofore known systems that require the caps of the bottles to be removed in order to fill the container with liquids.

As a result of the above, many institutions are switching to single use pre-packaged bottles of water and are discarding the plastic bottles after each use. Although helpful in preventing the spread of contagions, the drastic increase and disposal of these plastics has a tremendously negative effect on the environment.

Accordingly, it would be beneficial to provide a portable station that can quickly and easily fill multiple water bottles or other such devices in a sanitary manner that does not suffer from the drawbacks described above.

### SUMMARY OF THE INVENTION

The present invention is directed to a bottom feed portable bottle filling station. One embodiment of the present invention can include a cart having a frame that defines a top surface, and an inside space into which a liquid storage tank is positioned. A pump unit can be in fluid communication with the tank and can functions to supply liquid stored within the tank to one or more liquid distribution chambers.

In one embodiment, a plurality of bottom-feed dispensers is positioned along the top surface of the cart and are in fluid communication with the liquid distribution chambers. Each of the dispensers can include a valve and nozzle that are controlled by a switch. The nozzle is preferably positioned along the bottom wall of the dispenser and is configured to receive a bottle having a bottom-feed valve along the bottom end.

The bottom-feed valve of the bottle can include a one-way valve having a shape and a size that is suitable for receiving the nozzle. In one embodiment, the switch can also be positioned along the bottom wall of the dispenser and can be selectively activated by the bottom end of the bottle when positioned within the dispenser.

In the preferred embodiment, the pump unit can include an electric water pump, and the valves of each of the dispensers can be electrically fed by the pump unit. In one embodiment, two sets of tanks, pump units, liquid distribution chambers and dispensers can be provided to allow simultaneous filling of a plurality of water bottles with different liquids.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the bottom feed portable bottle filling station that is useful for understanding the inventive concepts disclosed herein.

FIG. 2 schematically shows the pump unit of the bottom feed portable bottle filling station, in accordance with one embodiment of the invention.

FIG. 3 is a cutout view of FIG. 1 showing a bottom feed dispenser of the bottom feed portable bottle filling station, in accordance with one embodiment of the invention.

FIG. 4 is a side view of a bottle of the bottom feed portable bottle filling station, in accordance with one embodiment of the invention.

FIG. 5 is a cutout view of the of the bottom feed portable bottle filling station in operation, in accordance with one embodiment of the invention.

FIG. 6 is a front view of the bottom feed portable bottle filling station, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “sanitary” refers to the functionality of the station that eliminates the need for a user to physically remove the bottle top or submerge a water bottle into a cooler, thereby contaminating the water with any residue located on the bottle body.

As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors such as opposing strips of hook and loop material (i.e. Velcro®), magnetic elements, and/or compression fittings such as clamps, tethers (e.g., zip ties), snaps and buttons, for example. This can also be accomplished through the use of any number of commercially available couplers such as threaded plumbing fittings (e.g., male and female couplers) and/or NPT fittings, for example.

As described herein, the term “permanently secured” shall be used to describe a situation wherein two or more objects are joined together in a manner so as to prevent the same objects from being separated. Several nonlimiting examples include various adhesives such as glue or resin, hardware such as nuts and bolts, and welds, for example.

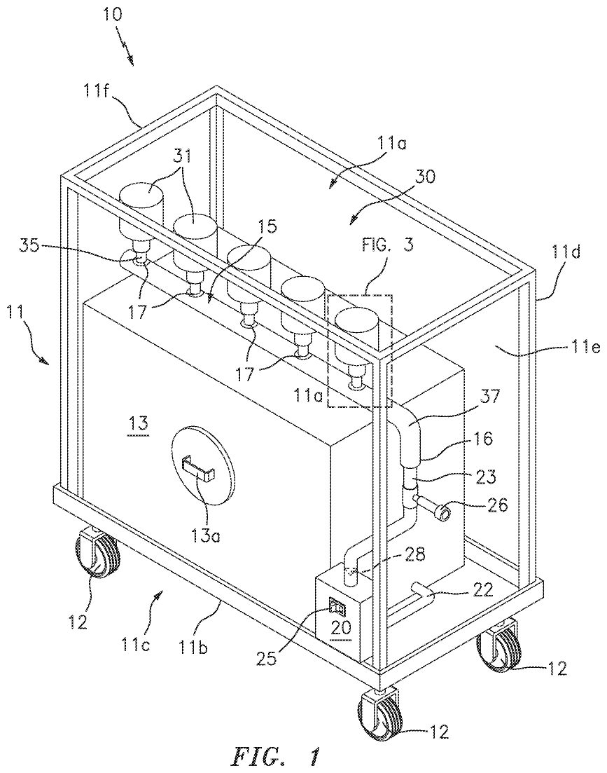

FIGS. 1-4 illustrate one embodiment of a bottom feed bottle filling station 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, the portable station 10 can include, essentially, a cart 11 having a storage tank 13, a liquid distribution chamber 15, and a pump unit 20 that supplies liquids to a plurality of bottom-feed dispensers 30.

In one embodiment, the cart 11 can include a generally rectangular-shaped body having a top surface 11a, a bottom surface 11b, an open front end 11c, a back end 11d and opposing sides 11e and 11f that form a hollow interior space. In one embodiment, one or more doors (not illustrated) can be hingedly secured along the top or sides of the open front end, so as to allow a user to selectively closed the doors to prevent access to the interior space. In one embodiment, the cart can also include a plurality of wheels 12 to allow the cart to be easily moved from one location to another.

As described herein, the cart can be constructed from any number of materials that are relatively strong and lightweight. Several nonlimiting examples include various plastics and metals, for example. Of course, any number of other shapes, sizes and construction materials are also contemplated.

The storage tank 13 can include a hollow watertight main body having a removable cap/lid section 13a for receiving liquids to be stored therein. The storage tank 13 can be in fluid communication with the pump unit 20 and can preferably be constructed from two shells of plastic having insulative foam secured therebetween. Of course, any number of other shapes, sizes and construction materials are also contemplated.

The liquid distribution chamber 15 can include any number of different shapes and sizes and can include an inlet 16 for engaging the outlet line 23 of the below described pump unit 20. The liquid distribution chamber including a plurality of couplers 17 for engaging and receiving a supply line 35 of each individual bottom feed dispenser 30.

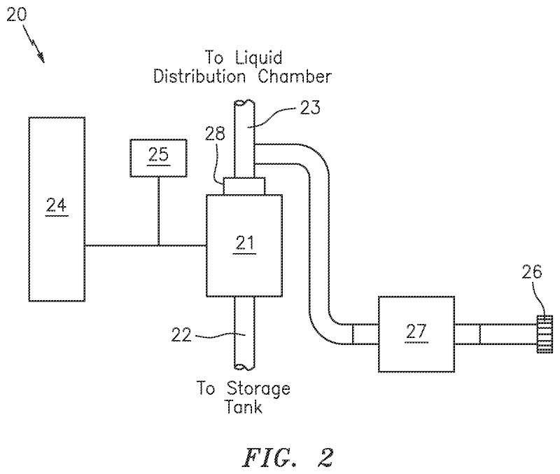

As shown best at FIG. 2, one embodiment of the pump unit 20 can include an electric water pump 21 that is interposed between a water inlet line 22 that is connected to the storage tank 13 and a water outlet line 23 that is connected to the inlet 16 of the liquid distribution chamber 15. The pump 21 can be connected to a power source 24 such as a battery and/or an electrical transformer and plug for connecting to an AC electrical outlet, for example.

Operation of the pump can be controlled by an electrical switch 25, which permits the pump to remove water from the tank 13 and supply the same to the liquid distribution chamber(s). In one embodiment, a threaded hose 26 and optional water filter 27 can be connected to the output line 23, in order to supply the liquid distribution chamber with water from a municipal water source, thus providing a bypass for the pump in the event of component failure. In such an embodiment, a one-way valve 28 can be provided to prevent backflow of the water supply into the pump and/or tank.

Of course, any number of other types of pumps such as a manual pump are also contemplated for use herein, either as the primary pumping mechanism, or as a backup pumping mechanism.

Although described above as utilizing a liquid distribution chamber for feeding each of the dispensers 30, other embodiments are also contemplated. For example, one nonlimiting embodiment can include a splitter that is disposed between the output line 23 of the pump unit 20, and each of the plurality of dispenser supply lines 35.

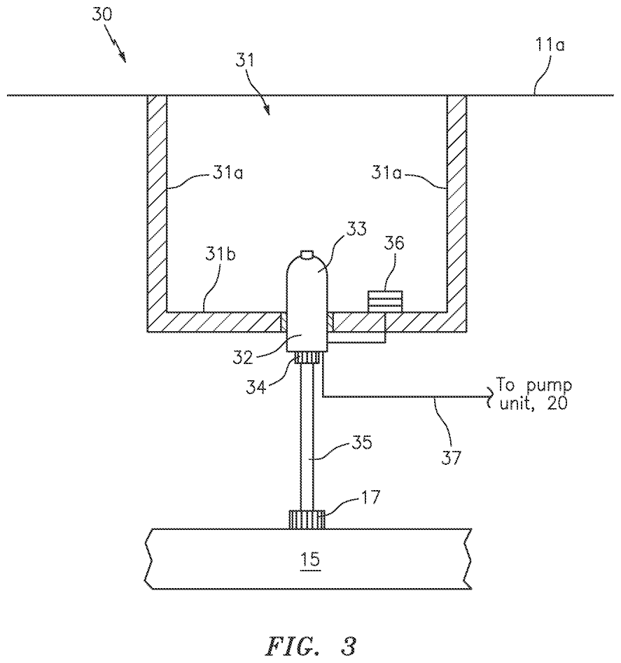

Cutout FIG. 3 illustrates one embodiment of a bottom feed dispenser 30 that includes a generally circular-shaped opening 31 having a continuous sidewall 31a and a bottom wall 31b. The opening can preferably be positioned so as to be flush with the top surface of the cart and such that the side and bottom walls are beneath the top surface 11a of the cart. Such a placement is preferred and advantageous, as it allows the entire top surface of the cart to be utilized for other purposes when the system is not actively filling water bottles. Of course, other embodiments are contemplated wherein the bottom and sidewalls extend away from the cart 11, so as to have a raised profile.

In either instance, a valve 32 can be positioned along the bottom wall and can include a discharge nozzle 33 that extends upward from the bottom wall. A dispenser supply line 35 can be connected between the valve 32 and the liquid distribution chamber 15 by couplers 34 and 17, respectively, so as to supply fluids from the liquid distribution chamber to the valve.

In one embodiment, the valve 32 can comprise an electrically powered one-way valve that is connected to a contact/pressure switch 36 for selectively permitting the valve to discharge fluids through the output nozzle. The valve and switch can include a discrete power source such as a battery, and/or can be electrically connected 37 to the power source of the pump unit 20 so as to receive operating power therefrom.

In the preferred embodiment, the switch 36 can be positioned within the opening 31 and along the bottom wall 31b so as to be activated upon contact with the bottom surface of a bottom-feed bottle 40 that is positioned within the opening. In this regard, it is important that the top of the switch 36 be positioned beneath the top of the nozzle 33, and that the nozzle be rigid, so as to not bend to a location below the switch. Such functionality ensuring the system will only discharge fluids into a bottle that is fitted with a bottom-feed adapter, and that is properly seated within the opening 31.

Although described above as including an electric valve and pressure switch that is positioned within the opening, many other embodiments are contemplated. To this end, the switch can include, comprise or consist of any number of devices capable of detecting the presence of a bottle and selectively activating the nozzle. Several nonlimiting examples include proximity switches and/or motion activated switches, for example. Additionally, the switch can be configured to operate when in proximity to a specific device, such as a magnet or RFID component, for example, so as to allow the system to work only with a specialized bottle.

Likewise, the switch for each dispenser may be located anywhere along or within the cart, so as to permit manual activation of a given dispenser by a user depressing the button.

Moreover, other embodiments are contemplated wherein the valve and/or switch are not electrical, and instead comprise manual components. To this end, the valve can comprise a manual one-way valve that is biased in the closed position, and the switch can be mechanically coupled to the valve. Upon receiving a pressing force onto the switch, the mechanical linkage can move the valve to the open position, thus allowing fluids supplied from the supply line 35 to pass through the valve and to be selectively discharged through nozzle.

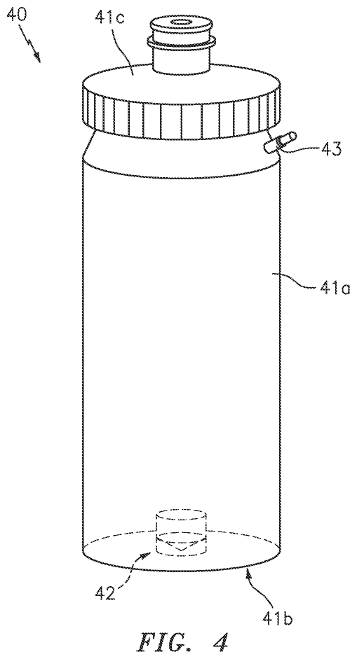

FIG. 4 illustrates one embodiment of a water bottle 40 having a bottom-feed adapter for use with the system 10. As shown, the bottle can include a continuous sidewall 41a, a bottom wall 41b and a sports cap 41c along the top end. The sports cap can have an open and closed position, as is known in the art, and/or can include a one way valve to allow the fluid to discharge upon a user squeezing the bottle.

In one embodiment, a one-way valve 42 can be positioned along the bottom end of the bottle, and can function to engage and receive the nozzle 33. In the preferred embodiment, the bottom-feed valve 42 can comprise a resilient member that is biased closed, and that can be manually opened by insertion of the nozzle 33. In one embodiment, a pressure valve 43 can be provided along the upper portion of the bottle, to provide an air release while filling the bottle. Of course, the bottle is not limited to such components and features, as any number of different types of containers capable of receiving a liquid from the system 10 are also contemplated for use herein.

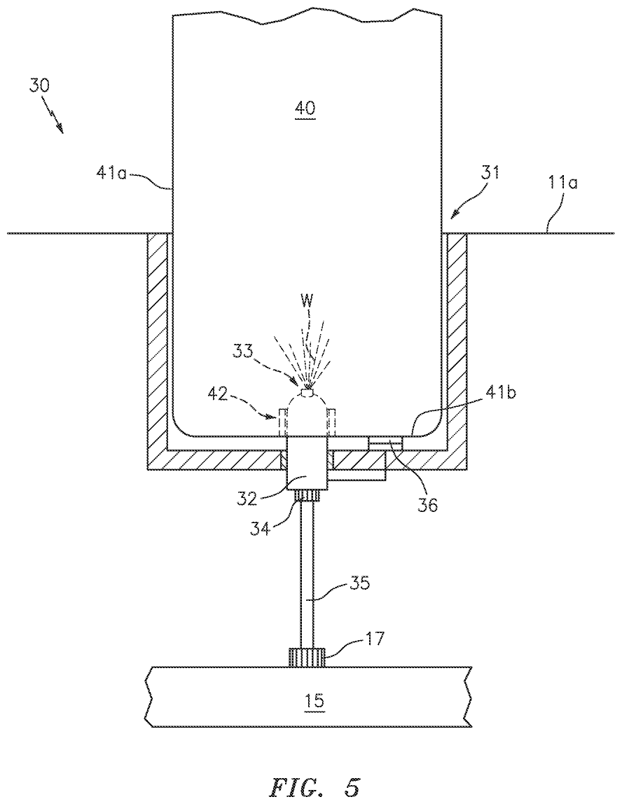

As shown at FIG. 5, The bottle 40 can be positioned within the opening 31 of a dispenser 30 and can be lowered until the nozzle 33 is located within the bottom-feed valve 42. When the bottom wall 41b of the bottle makes contact with the switch 36, the valve 32 of the dispenser will open, and permit the pressurized fluid W supplied by the liquid distribution chamber 15, tank 13 and pump unit 20 to be dispensed into the bottle through the nozzle 33.

When the bottle is full, the user can simply lift the bottle upward at which time the switch 36 will shut the dispenser valve 32, and the bottom-feed valve 42 of the bottle will close to prevent the water within the bottle from escaping.

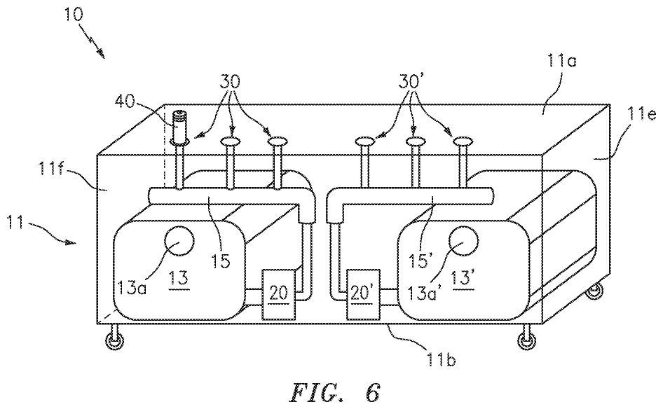

Although described above with regard to a single tank, a single pump and a single liquid distribution chamber, this is for illustrative purposes only, as many other variants are also contemplated. For example, FIG. 6 illustrates one embodiment of the bottom feed dispensing station 10 that includes having two tanks 13 and 13′, two liquid distribution chambers 15 and 15′, two pumping units 20 and 20′ that feed two sets of bottom feed dispensers 30 and 30′. Each of the components 13′, 15′, 20′ and 30′ being identical to those described above at 31, 15, 20 and 30, respectively.

Such a configuration advantageously allowing each tank 13 and 13′ to be filled with different types of fluids (e.g., water and a sports drink, for example) which can then be provided to specific bottom feed dispensers 30 and 30′ via the different liquid distribution chambers. As such, a user can advantageously full multiple bottles with different types of fluids simultaneously.

Accordingly, the above described bottom feed portable bottle filling station 10 provides a novel system for filling water bottles that does not require the bottles to be physically opened, so as to simultaneously fill any number of water bottles with one or more different types of fluids in a secure and sanitary manner.

As described herein, one or more elements of the portable station 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A portable hydration and bottle filling station, comprising:
a cart having a frame that defines a top surface, a bottom surface, and an interior space;
a liquid storage tank that is positioned along the cart frame;
a pump unit that is in fluid communication with the liquid storage tank;
a liquid distribution chamber that is in fluid communication with the pump unit; and
a plurality of dispensers that are positioned along the cart, each of the dispensers being in fluid communication with the liquid distribution chamber, and being configured to dispense a fluid stored within the liquid storage tank into a bottle.

2. The station of claim 1, wherein each of the plurality of dispensers include an opening having a sidewall and a bottom wall.

3. The system of claim 2, wherein each of the plurality of dispensers includes a valve having a discharge nozzle.

4. The system of claim 3, wherein the discharge nozzle is positioned along the bottom wall of each of the plurality of dispensers.

5. The system of claim 3, further comprising:
a switch that is in communication with the valve, said switch being configured to selectively operate the valve.

6. The station of claim 3, further comprising:
a plurality of water bottles, each comprising a one-way valve that is configured to engage the discharge nozzle of each of the dispensers.

7. The station of claim 1, wherein the pump unit further comprises:
an electric water pump that is interposed between a water inlet line and a water outlet line;
a power source that is electrically connected to the electric water pump; and
a control switch for controlling an operation of the electric water pump.

8. The station of claim 1, wherein the liquid storage tank is insulated and includes a removable cap for accessing an interior portion thereof.
